(19) United States
(12) Patent Application Publication
(10) Pub. No.: US 2026/0032180 A1
(43) Pub. Date: Jan. 29, 2026

(54) SYSTEM AND METHOD FOR REMEMBERING A RETURNING USER

(71) Applicant: Visa International Service Association, San Francisco, CA (US)

(72) Inventor: PRATOMCHAPRATOMCHAI PUSAKOLCHAROENSAK, Wembley (GB)

(73) Assignee: Visa International Service Association, San Francisco, CA (US)

(21) Appl. No.: 19/144,326

(22) PCT Filed: Dec. 23, 2023
(86) PCT No.: PCT/US23/85871

§ 371 Date: Jun. 27, 2025

Related U.S. Application Data
(60) Provisional application No. 63/436,091, filed on Dec. 29, 2022.

(51) Int. Cl. H04L 67/50; G06F 21/60; G06T 11/00; H04L 67/142

(52) U.S. Cl. CPC H04L 67/535; G06F 21/602; G06T 11/00; H04L 67/142

(57) ABSTRACT

In some embodiments, a system includes a processor: and a non-transitory computer readable medium coupled to the processor. In some embodiments, the non-transitory computer readable medium includes code that; receives a steganography-based scalable vector graphics (SVG) image request from a browser associated with a webpage; generates, based on the receipt of the steganography-based SVG image request, the steganography-based SVG image; and provides the steganography-based SVG image to a browser cache of the browser for use in determining whether a user of the webpage is a return user.

### CROSS REFERENCE TO RELATED APPLICATION

This application claims the benefit and priority of U.S. Provisional Patent Application No. 63/436,091, entitled “SYSTEM AND METHOD FOR REMEMBERING A RETURNING USER”, filed on Dec. 29, 2022, the full disclosure of the above referenced application is incorporated herein by reference.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

In internet applications of today, when users access websites via the internet, users returning to a website may be identified using cookies. Cookies are small text files that are stored in the cache of a browser and generally contain identifiable information about a user. Cookies were created to be used with web browsers to allow website owners to personalize and save information about a user's browsing session. However, cookies are also used by third-party advertisers to track users across the internet, which may be considered a violation of privacy. As a result, web browser vendors have developed privacy applications that prevent third parties from creating and accessing cookies. The privacy applications seek to protect the online privacy of a user, limiting the ways advertisers and website owners track users across domains to personalize content and advertise goods and services. However, implementation of the privacy applications come with a side effect that prevents the legitimate use of cookies to identify users or devices by third-party services for security purposes. Therefore, a need exists to develop an alternative to cookies for website applications.

### BRIEF DESCRIPTION OF THE DRAWINGS

FIG. 1A illustrates a block diagram of a web server that is utilized in identifying a returning user of a steganography-configured webpage in accordance with some embodiments.

FIG. 1B illustrates a block diagram of a user device that is utilized to access a steganography-configured webpage in accordance with some embodiments.

FIG. 1C illustrates an example network that includes the web server of FIG. 1A and the user device of FIG. 1B in accordance with some embodiments.

FIG. 2 illustrates a block diagram of a steganography-based scalable vector graphics (SVG) image in accordance with some embodiments.

FIG. 3 illustrates a steganography-based SVG image generation method in accordance with some embodiments.

FIG. 4 illustrates a steganography-based return user identification method in accordance with some embodiments.

FIG. 5 illustrates an example steganography-based SVG image in accordance with some embodiments.

### DETAILED DESCRIPTION

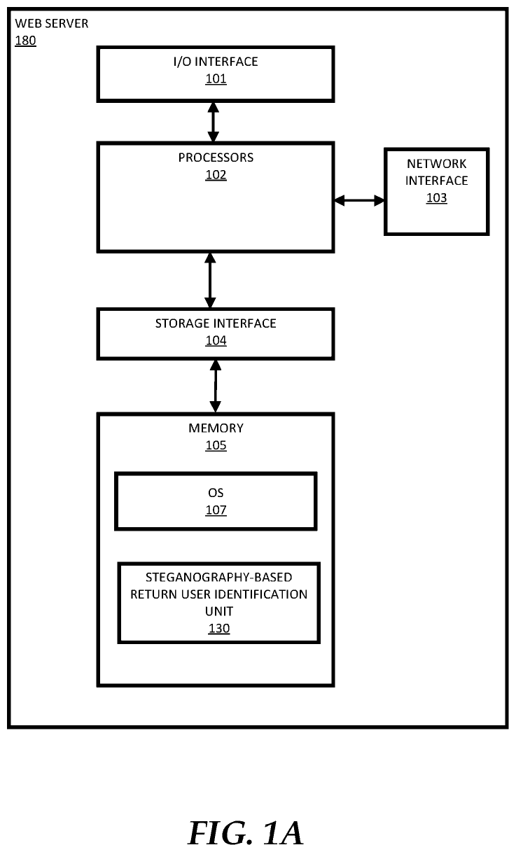

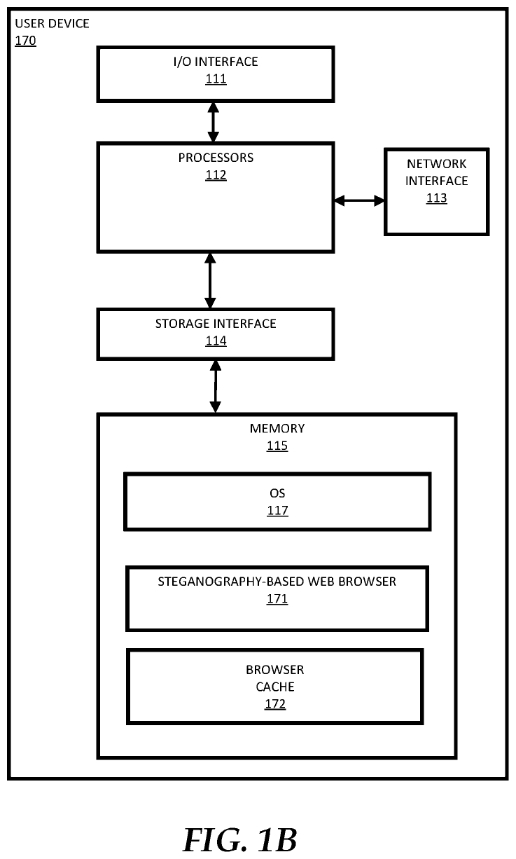

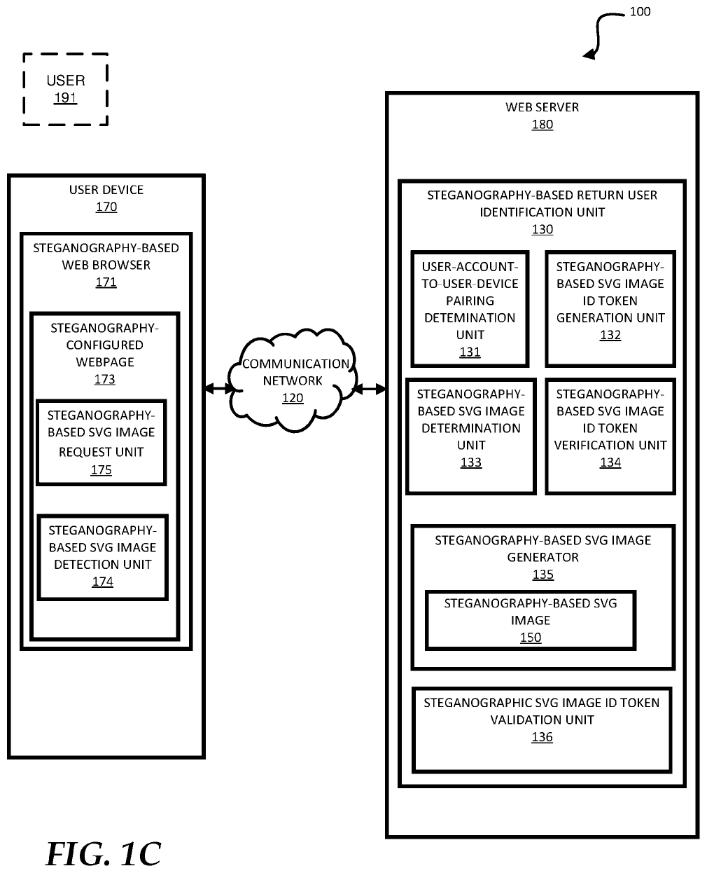

FIG. 1A illustrates a block diagram of an exemplary web server 180 for implementing embodiments consistent with the present disclosure. In some embodiments, the web server 180 is a computer system that includes an input/output (IO) interface 101, processor/s 102, a storage interface 104, a network interface 103, and memory 105. In some embodiments, memory 105 may include an operating system (OS) 107, and a steganography-based return user identification unit 130. In some nonlimiting embodiments, the web server 180 is a web server that utilizes the steganography-based return user identification unit 130 to implement some embodiments consistent with the present disclosure as described further in detail herein.

In some embodiments, the processors 102 may include at least one data processor for executing executable code and program components described herein. The processors 102 may include specialized processing units such as integrated system (bus) controllers, memory management control units, floating point units, graphics processing units, digital signal processing units, etc. In some embodiments, the processors 102 may be disposed in communication with one or more input/output (I/O) devices (not shown) via an I/O interface 101. The I/O interface 101 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMi), RF antennas, S-Video, VGA, IEEE 802.1 n/b/g/n/x, Bluetooth®, cellular (e.g., code-division multiple access (CDMA), high-speed packet access (HSPA+), global system for mobile communications (GSM), long-term evolution (LTE), WiMax®, or the like), etc.

In some embodiments, using the I/O interface 101, the web server 180 may communicate with one or more I/O devices. For example, an input device (not shown) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device (not shown) may be a printer, fax machine, video display (e.g., cathode ray tube (CRT), liquid crystal display (LCD), light-emitting diode (LED), plasma display panel (PDP), Organic light-emitting diode display (OLED) or the like), audio speaker, etc.

In some embodiments, the processors 102 may be disposed in communication with a communication network 120, illustrated in FIG. 1C, or other type of network via a network interface 103. The network interface 103 may communicate with the communication network 120. The network interface 103 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The communication network 120 may include, without limitation, a direct interconnection, e-commerce network, a peer to peer (P2P) network, local area network (LAN), wide area network (WAN), wireless network (e.g., using Wireless Application Protocol), the internet, Wi-Fi®, etc. Using the network interface 103 and the communication network 120, the web server 180 may communicate with the one or more service operators, user devices (e.g., user device 170), etc.

In some non-limiting embodiments or aspects, the processors 102 may be disposed in communication with a memory 105 (e.g., RAM, ROM, etc.) via a storage interface 104. In some embodiments, the storage interface 104 may connect to memory 105 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems interface (SCSI), etc. The memory drives may further include a drum, magnetic disc drive, magneto-optical drive, optical drive, Redundant Array of Independent Discs (RAID), solid-state memory devices, solid-state drives, etc.

In some embodiments, the memory 105 may store a collection of program or database components, including, without limitation, an operating system 107, web server applications, web pages, etc. In some embodiments, web server 180 may serve as a host for webpages and allow a user (e.g., user 191) of user device 190 to access a webpage or webpages (e.g., steganography-configured webpage 173) via steganography-based web browser 171, illustrated by way of example in FIG. 1C. In some non-limiting embodiments or aspects, the web server 180 may store user/application data, such as the data, variables, records, etc. as described in this disclosure. Such databases may be implemented as fault-tolerant, relational, scalable, secure databases such as Oracle or Sybase.

In some embodiments, the operating system 107 may facilitate resource management and operation of the web server 180. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® OS®, GOOGLE™ ANDROID™, BLACKBERRY® OS, or the like.

FIG. 1B illustrates a block diagram of an exemplary user device 170 for implementing embodiments consistent with the present disclosure. In some embodiments, the user device 170 includes an input/output (IO) interface 111, processor/s 112, a storage interface 114, a network interface 113, and memory 115. In some embodiments, memory 115 may include an operating system (OS) 117, a browser cache 172, and a steganography-based web browser 171. In some nonlimiting embodiments or aspects, the user device 170 may utilize steganography-based web browser 171 to implement some embodiments consistent with the present disclosure and described further in detail herein.

In some embodiments, processors 112 may include at least one data processor for

executing executable code and program components described herein. In some embodiments, the processors 112 may include specialized processing units such as integrated system (bus) controllers, memory management control units, floating point units, graphics processing units, digital signal processing units, etc. In some embodiments, the processors 112 may be disposed in communication with one or more input/output (I/O) devices (not shown) via an I/O interface 111. The I/O interface 111 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMi), RF antennas, S-Video, VGA, IEEE 802.1 n/b/g/n/x, Bluetooth®, cellular (e.g., code-division multiple access (CDMA), high-speed packet access (HSPA+), global system for mobile communications (GSM), long-term evolution (LTE), WiMax®, or the like), etc.

In some embodiments, using the I/O interface 111, the user device 170 may communicate with one or more I/O devices. For example, an input device (not shown) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. An output device (not shown) may be a printer, fax machine, video display (e.g., cathode ray tube (CRT), liquid crystal display (LCD), light-emitting diode (LED), plasma display panel (PDP), Organic light-emitting diode display (OLED) or the like), audio speaker, etc.

In some embodiments, the processors 112 may be disposed in communication with a communication network 120 or other type of network via a network interface 113. The network interface 113 may communicate with the communication network 120. The network interface 113 may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. Using the network interface 113 and the communication network 120, the user device 170 may communicate with one or more service operators, servers (e.g., web server 180), etc.

In some non-limiting embodiments or aspects, the processors 112 may be disposed in communication with a memory 115 (e.g., RAM, ROM, etc.) via a storage interface 114. In some embodiments, the storage interface 114 may connect to memory 115 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems interface (SCSI), etc. The memory drives may further include a drum, magnetic disc drive, magneto-optical drive, optical drive, Redundant Array of Independent Discs (RAID), solid-state memory devices, solid-state drives, etc. In some embodiments, memory 115 may include browser cache 172. In some embodiments, browser cache 172 may be located external to memory 115. In some embodiments, browser cache 172 is a cache that is utilized by, for example, steganography-based web browser 171 to store webpages (e.g., steganography-configured webpage 173 downloaded from web server 180) and other information associated with steganography-based web browser 171, as described further in detail herein.

In some embodiments, the memory 115 may store a collection of program or database components, etc., including, without limitation, an operating system 117, steganography-based web browser 171, steganography-configured webpage 173, web server applications, etc. In some non-limiting embodiments or aspects, the user device 170 may store user/application data, such as the data, variables, records, etc. Such databases may be implemented as fault-tolerant, relational, scalable, secure databases such as Oracle or Sybase.

In some embodiments, the operating system 117 may facilitate resource management and operation of the user device 170. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XP®, VISTA®/7/8, 10 etc.), APPLE® OS®, GOOGLE™ ANDROID™, BLACKBERRY® OS, or the like.

In some non-limiting embodiments or aspects, the user device 170 may implement a steganography-based web browser 171 as a stored program component. In some embodiments, the steganography-based web browser 171 may be a hypertext viewing application that is configured to operate according to embodiments described herein. In some embodiments, secure web browsing may be provided using Secure Hypertext Transport Protocol (HTTPS), Secure Sockets Layer (SSL), Transport Layer Security (TLS), etc. In some embodiments, steganography-based web browser 171 may utilize facilities such as AJAX, DHTML, ADOBE® FLASH®, JAVASCRIPT®, JAVA®, Application Programming Interfaces (APIs), etc.

Furthermore, one or more computer-readable storage media may be utilized in implementing embodiments consistent with the present disclosure. In some embodiments, a computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, e.g., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

FIG. 1C illustrates an example network 100 in accordance with some embodiments. In some embodiments, network 100 includes user device 170, communication network 120, and web server 180. In some embodiments, network 100 is a network that is configured to allow user 191 to utilize steganography-based web browser 171 of user device 170 to access, via communication network 120, steganography-configured webpage 173 from web server 180 using the internet. In some embodiments, user 191 may be, for example, a person that utilizes steganography-based web browser 171 of user device 170 to access steganography-configured webpage 173. In some embodiments, the steganography-configured webpage 173 is hosted by web server 180 and provided to steganography-based web browser 171 of user device 170 via the internet using network 100.

In some embodiments, steganography-based web browser 171 is a web browser that, in addition to being configured to perform traditional web browser operations required to allow user 191 to access the internet, is configured to perform steganography-based web browser operations that allow user 191 to access steganography-configured webpage 173 from web server 180 such that user 191 may be identified as a return user of steganography-configured webpage 173, as described further in detail herein. In some embodiments, steganography-based web browser 171 may be configured to allow steganography-configured webpage 173 to be viewed by user 191. In some embodiments, after being provided to user device 170 from web server 180, steganography-configured webpage 173 may be stored in browser cache 172 and viewed in steganography-based web browser 171.

In some embodiments, steganography-configured webpage 173 is a webpage hosted by web server 180 that is configured to be utilized to perform steganography-based webpage operations utilized in identifying a return user of the steganography-configured webpage 173. In some embodiments, steganography-configured webpage 173 includes a steganography-based SVG image request unit 175 and a steganography-based SVG image detection unit 174. In some embodiments, steganography-based SVG image request unit 175 is executable code configured to generate a steganography-based SVG image request to request a steganography-based SVG image 150 from steganography-based return user identification unit 130 of web server 180, described further in detail herein. In some embodiments, steganography-based SVG image detection unit 174 is executable code that is configured to determine whether an SVG image received from web server 180 is a steganography-based SVG image, described further in detail herein. In some embodiments, the executable code utilized in the steganography-based SVG image request unit 175 and/or the steganography-based SVG image detection unit 174 may be in the form of a script that is coded in, for example, JAVASCRIPT® or some other programming language.

In some nonlimiting embodiments, as stated previously, the web server 180 is a web server that utilizes the steganography-based return user identification unit 130 to implement some embodiments consistent with the present disclosure. In some embodiments, steganography-based return user identification unit 130 is executable code and/or hardware in web server 180 configured to perform steganography-based return user identification operations that are utilized in identifying a return user of steganography-configured webpage 173. In some embodiments, as stated previously, steganography-configured webpage 173 is a webpage hosted by web server 180 that is configured to be utilized to perform steganography-based webpage operations utilized in identifying a return user of the steganography-configured webpage 173. In some embodiments, steganography-based return user identification unit 130 of web server 180 includes a user-account-to-user-device pairing determination unit 131, a steganography-based SVG image ID token generation unit 132, a steganography-based SVG image determination unit 133, a steganography-based SVG image ID token verification unit 134, a steganography-based SVG image generator 135, and a steganography-based SVG image ID token validation unit 136.

In some embodiments, user-account-to-user-device pairing determination unit 131 is executable code and/or hardware configured to utilize a user credential payload received from steganography-configured webpage 173 to determine whether a user account associated with user 191 is linked to user device 170. In some embodiments, steganography-based SVG image ID token generation unit 132 is executable code and/or hardware configured to generate a steganography-based SVG image ID token that is utilized to generate steganography-based SVG image 150 and identify a return user of steganography-configured webpage 173. In some embodiments, the steganography-based SVG image determination unit 133 is executable code configured to determine whether a steganography-based SVG image ID token is appended to the steganography-based SVG image request received from steganography-configured webpage 173. In some embodiments, steganography-based SVG image ID token verification unit 134 is executable code and/or equivalent hardware configured to verify that a steganography-based SVG image ID token included in the steganography-based SVG image request is a valid steganography-based SVG image ID token. In some embodiments, steganography-based SVG image generator 135 is executable code and/or hardware configured to generate steganography-based SVG image 150. In some embodiments, steganography-based SVG image ID token validation unit 136 is executable code and/or hardware configured to validate a steganography-based SVG image ID token.

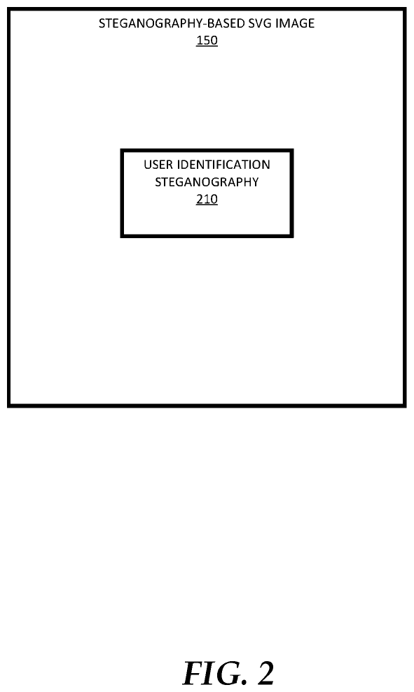

In some embodiments, user-account-to-user-device pairing determination unit 131, steganography-based SVG image ID token generation unit 132, steganography-based SVG image determination unit 133, steganography-based SVG image ID token verification unit 134, steganography-based SVG image generator 135, and steganography-based SVG image ID token validation unit 136 are described further in detail herein with reference to FIG. 2-FIG. 5.

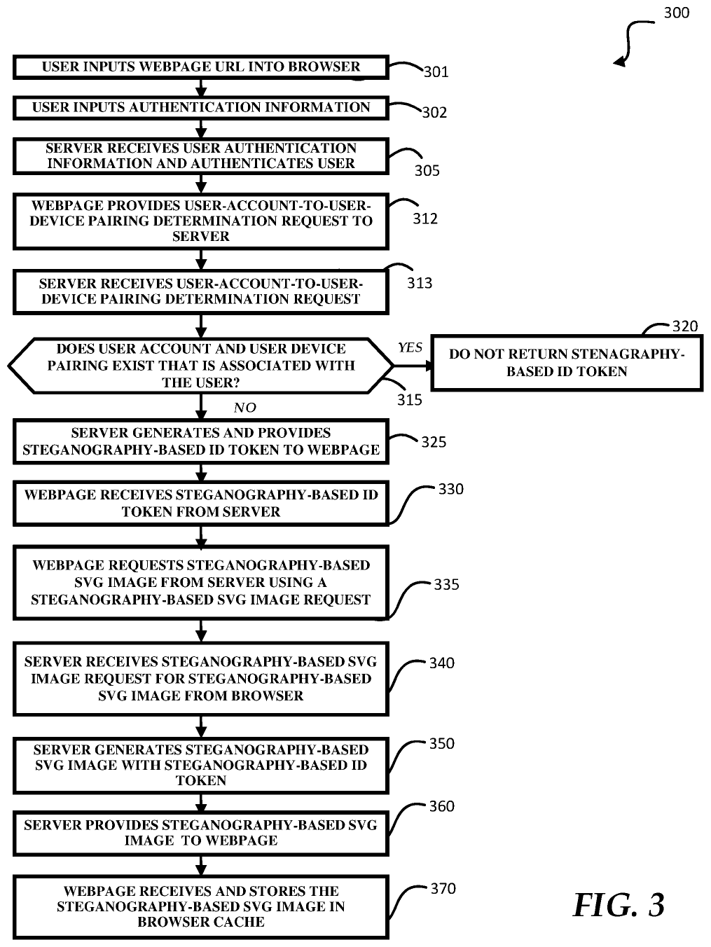

FIG. 2 illustrates a block diagram of a steganography-based SVG image 150 in accordance with some embodiments. In some embodiments, the steganography-based SVG image 150 is an SVG image generated by steganography-based return user identification unit 130 that includes user identification steganography 210 that is utilized to identify a return user of steganography-configured webpage 173. In some embodiments, user identification steganography 210 is user identification data and information that is embedded into steganography-based SVG image 150 using steganography that is utilized to identify a return user of steganography-configured webpage 173. In some embodiments, the user identification data and information may include, for example, a steganography-based SVG image identification (ID) token. In some embodiments, the steganography-based SVG image ID token is an identification token (generated by, for example, steganography-based SVG image ID token generation unit 132 illustrated in FIG. 1C) that is configured to be utilized to generate the steganography-based SVG image 150 and identify whether user 191 is a return user of steganography-configured webpage 173. In some embodiments, the operations utilized to generate the steganography-based SVG image 150 and identify a return user of steganography-configured webpage 173 are described further herein with reference to FIG. 3-FIG. 5.

FIG. 3 illustrates a steganography-based SVG image generation method 300 in accordance with some embodiments. In some embodiments, the steganography-based SVG image generation method 300 is a method that is utilized to generate a steganography-based SVG image 150 that is utilized to identify a return user of steganography-configured webpage 173 accessed via steganography-based web browser 171. In some embodiments, the method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the steganography-based return user identification unit 130 is configured to perform at least a portion of the steganography-based SVG image generation method 300 described herein in accordance with some embodiments. In some embodiments, the steganography-based SVG image generation method 300 is described with reference to the figures described herein.

In some embodiments, at operation 301, user 191 inputs a URL address associated with steganography-configured webpage 173 into the address bar of steganography-based web browser 171. In some embodiments, in response to user 191 inputting the URL address associated with the steganography-configured webpage 173 into the address bar, steganography-based web browser 171 sends an HTTPS request to web server 180 for the HTML content of steganography-configured webpage 173 associated with the URL address input by user 191. In some embodiments, web server 180 responds to the HTTPS request by providing the HTML content of steganography-configured webpage 173 to steganography-based web browser 171. In some embodiments, after receiving the HTML content of steganography-configured webpage 173, operation 301 proceeds to operation 302.

In some embodiments, at operation 302, user 191 of user device 170 inputs user authentication information into steganography-configured webpage 173 of steganography-based web browser 171. In some embodiments, user authentication information is user information input into steganography-configured webpage 173 of steganography-based web browser 171 that is utilized to authenticate user 191 of user device 170. In some embodiments, the user authentication information is utilized to allow user 191 to gain authorization to secured information via steganography-configured webpage 173. In some embodiments, steganography-configured webpage 173 may be, for example, a steganography-configured webpage that is utilized to access a shopping platform, financial platform, etc. In some embodiments, the user authentication information may be, for example, a user identification (ID), a user password, a user pin code, user facial ID, or the like, that is utilized to access, for example, secure information from web server 180 via steganography-configured webpage 173. In some embodiments, after the user authentication information is input into steganography-configured webpage 173, operation 302 proceeds to operation 305.

In some embodiments, at operation 305, web server 180 receives the user authentication information from steganography-configured webpage 173 and authenticates user 191 of user device 170. In some embodiments, web server 180 authenticates user 191 of user device 170 in accordance with standard authentication operations utilized to authenticate users of user devices in order to access secure websites from user devices as known in the art. In some embodiments, after web server 180 authenticates user 191 of steganography-configured webpage 173, operation 305 proceeds to operation 312.

In some embodiments, at operation 312, after user 191 is authenticated by web server 180, steganography-configured webpage 173 submits a user-account-to-user-device pairing determination request to steganography-based return user identification unit 130 of web server 180. In some embodiments, the user-account-to-user-device pairing determination request is a request sent from steganography-configured webpage 173 to steganography-based return user identification unit 130 that is configured to indicate to steganography-based return user identification unit 130 of web server 180 to perform a user-account-to-user-device pairing determination assessment associated with user 191 of user device 170. In some embodiments, user-account-to-user-device pairing determination assessment includes determining whether a user account associated with user 191 of user device 170 is paired with and/or linked to user device 170. In some embodiments, a user account is an account (e.g., bank account, financial account, system account, etc.) associated with user 191 that is managed by an institution (e.g., bank, payment processor, etc.) utilizing web server 180. In some embodiments, a user account may include records associated with the user account that may include information related to user 191, including but not limited to personal details, financial transactions, account balances, and other relevant data. In some embodiments, a user account may be paired with user device 170 at web server 180 for purposes of accessing secured information via steganography-configured webpage 173.

In some embodiments, the user-account-to-user-device pairing determination request submitted to steganography-based return user identification unit 130 of web server 180 includes, for example, a user credential payload. In some embodiments, the user credential payload is a payload of user credentials associated with user 191 of user device 170 that is provided as part of the user-account-to-user-device pairing determination request. In some embodiments, the user credential payload includes, for example, user identification information associated with user 191 of user device 170 and user device information associated with the user device 170. In some embodiments, user identification information includes, for example, a username of user 191 and a user email address of user 191. In some embodiments, user device information includes, for example, a user device ID and a user agent. In some embodiments, a user agent is a user agent of steganography-based web browser 171. In some embodiments, the user credential payload may be provided to steganography-based return user identification unit 130 of web server 180 from user device 170 via an application programming interface (API) of steganography-configured webpage 173 or steganography-based web browser 171 that is configured to be utilized to send the user credential payload to web server 180. In some embodiments, an example of a user credential payload provided by, for example, the API of steganography-configured webpage 173 or steganography-based web browser 171, is shown below:

```
{
  “userId” : “Username/email”,
    “deviceInfo” : {
      “dvcId” : “A fingerprint of the device”,
      “userAgent” : “base64 encoding of the browsers userAgent” }
}
```

In some embodiments, after steganography-configured webpage 173 provides the user-account-to-user-device pairing determination request to steganography-based return user identification unit 130 of web server 180, operation 312 proceeds to operation 313.

In some embodiments, at operation 313, user-account-to-user-device pairing determination unit 131 of steganography-based return user identification unit 130 receives the user-account-to-user-device pairing determination request from steganography-configured webpage 173. In some embodiments, user-account-to-user-device pairing determination unit 131 receives the user credential payload as part of the user-account-to-user-device pairing determination request from steganography-configured webpage 173. In some embodiments, as stated previously, the user-account-to-user-device pairing determination unit 131 is executable code and/or hardware configured to utilize the user credential payload received from steganography-configured webpage 173 to determine whether a user account associated with user 191 is linked to user device 170. In some embodiments, after user-account-to-user-device pairing determination unit 131 receives the user-account-to-user-device pairing determination request, operation 313 proceeds to operation 315.

In some embodiments, at operation 315, user-account-to-user-device pairing determination unit 131 of steganography-based return user identification unit 130 determines whether a user account associated with user 191 and user device 170 are paired or linked by performing the user-account-to-user-device pairing determination assessment. In some embodiments, the user-account-to-user-device pairing determination unit 131 performs the user-account-to-user-device pairing determination assessment by assessing a user-account pairing database of stored pairings of user accounts that are linked to user devices at web server 180. In some embodiments, the user-account pairing database is a database associated with web server 180 that is configured to store pairings of user accounts and user devices that are linked for, for example, user account access and operational purposes. In some embodiments, user-account-to-user-device pairing determination unit 131 assesses the user-account pairing database of stored pairings of user accounts and user devices by comparing the received user credentials provided in the user-account-to-user-device pairing determination request with the stored pairings of user accounts and user devices. In some embodiments, the result of the user-account-to-user-device determination assessment performed by the user-account-to-user-device pairing determination unit 131 is either that there is a user-account-to-user-device pairing (e.g., a user-account-to-user-device pairing for the user credentials provided in the user-account-to-user-device pairing determination request), or that there is not a user account-to-user-device pairing (e.g., not a user account-to-user-device pairing for the user credentials provided in the user-account-to-user-device pairing determination request). In some embodiments, after the user-account-to-user-device pairing determination unit 131 of steganography-based return user identification unit 130 performs the user-account-to-user-device determination assessment, operation 315 proceeds either to operation 320 or operation 325.

In some embodiments, at operation 320, when user-account-to-user-device pairing determination unit 131 of steganography-based return user identification unit 130 determines that the user account associated with user 191 and user device 170 are paired, steganography-based return user identification unit 130 of web server 180 does not return a steganography-based SVG image ID token. In some embodiments, at operation 325, when user-account-to-user-device pairing determination unit 131 determines that the user account associated with user 191 of user device 170 and user device 170 are not paired, steganography-based SVG image ID token generation unit 132 of web server 180 generates a steganography-based SVG image ID token. In some embodiments, as stated previously, the steganography-based SVG image ID token is an identification token generated by steganography-based SVG image ID token generation unit 132 that is configured to be utilized to identify whether user 191 is a return user of steganography-configured webpage 173 and to generate the steganography-based SVG image 150. In some embodiments, the steganography-based SVG image ID token includes user identification data and information that identifies user 191 and the user device 170 and/or steganography-based web browser 171 utilized by user 191. An example steganography-based SVG image ID token is illustrated below:
<id_token>
where id_token is a steganography-based SVG image ID token that is configured to be utilized to identify a user ID of user 191, a user device ID of user device 170, and a browser ID of steganography-based web browser 171. In some embodiments, the steganography-based SVG image ID token may include a fingerprint ID of user device 170 and/or the steganography-based web browser 171. In some embodiments, for example, the fingerprint ID may be the user device 170 fingerprint ID and/or a browser fingerprint ID, such as, for example, id-123. In some embodiments, the generated fingerprint ID may be embedded and stored using steganography in a data attribute of an SVG image to generate the steganography-based SVG image 150. In some embodiments, the data attribute may be, for example, a data-* attribute, where data-* attribute is an attribute that allows a developer at web server 180 to store additional data associated with an SVG element.

In some embodiments, the steganography-based SVG image ID token is configured to indicate to the steganography-based return user identification unit 130, upon return of the steganography-based SVG image ID token from the steganography-configured webpage 173 via steganography-based web browser 171 (described further in detail herein), to generate steganography-based SVG image 150. In some embodiments, the steganography-based SVG image ID token is configured to indicate to the steganography-based return user identification unit 130, upon return of the steganography-based SVG image ID token from the steganography-configured webpage 173 via steganography-based web browser 171, to generate a steganography-based SVG image 150 by appending the steganography-based SVG image ID token to the end of a steganography-based SVG image request. In some embodiments, the steganography-based SVG image ID token is utilized by the steganography-based return user identification unit 130 to verify the identity of user 191 and user device 170 and provide user 191 and user device 170 permission to access protected resources or services provided by, for example, web server 180.

In some embodiments, prior to being provided to user device 170, the steganography-based SVG image ID token generated by the steganography-based return user identification unit 130 is stored in a database coupled to web server 180. In some embodiments, after generating the steganography-based SVG image ID token, steganography-based return user identification unit 130 provides the steganography-based SVG image ID token to steganography-configured webpage 173 of steganography-based web browser 171. In some embodiments, operation 325 proceeds to operation 330.

In some embodiments, at operation 330, steganography-configured webpage 173, via steganography-based web browser 171, receives the steganography-based SVG image ID token from steganography-based return user identification unit 130 of web server 180 and, at operation 335, requests a steganography-based SVG image from steganography-based SVG image ID token generation unit 132 of steganography-based return user identification unit 130. In some embodiments, steganography-configured webpage 173 requests a steganography-based SVG image from steganography-based SVG image ID token generation unit 132 of steganography-based return user identification unit 130 using a steganography-based SVG image request that is provided to steganography-based return user identification unit 130. In some embodiments, steganography-configured webpage 173 includes a steganography-based SVG image request unit 175. In some embodiments, as stated previously, steganography-based SVG image request unit 175 is executable code configured to generate the steganography-based SVG image request. In some embodiments, a steganography-based SVG image request is a request for a steganography-based SVG image that is provided from steganography-configured webpage 173 via steganography-based web browser 171 to steganography-based return user identification unit 130 of web server 180. In some embodiments, the steganography-based SVG image request is configured to indicate to the steganography-based return user identification unit 130 to generate the steganography-based SVG image 150.

In some embodiments, the steganography-based SVG image request is generated by the steganography-based SVG image request unit 175 by appending the steganography-based SVG image ID token received from web server 180 to the end of an SVG image request URL (e.g., appending as a steganography-based URL parameter). In some embodiments, the steganography-based URL parameter may be a steganography-based SVG image ID token that is utilized to identify user 191, user device 170, and the steganography-based web browser 171. An example of steganography-based SVG image request with an appended steganography-based SVG image ID token is illustrated below:
https://mydomain.com/path-to-asset/image.svg?v=<id_token>”/
where id_token is the appended steganography-based SVG image ID token.

In some embodiments, by appending a steganography-based URL parameter (e.g., steganography-based SVG image ID token) to the end of an SVG image request URL, the steganography-based URL parameter (e.g., steganography-based SVG image ID token) indicates to the web server 180 to encrypt the steganography-based SVG image ID token into the requested SVG image. In some embodiments, web server 180 encrypts the steganography-based SVG image ID token into the requested SVG image such that, upon return receipt and storage of the steganography-based SVG image from web server 180 in browser cache 172, the steganography-based web browser 171 may search for the steganography-based SVG image ID token. In addition, by appending the steganography-based SVG image ID token to the end of the SVG image, web server 180 is notified that a script (e.g., steganography-based SVG image detection unit 174) of steganography-configured webpage 173 is awaiting a response from web server 180.

In some embodiments, by appending the steganography-based SVG image ID token to the end of a steganography-based SVG image request, the steganography-based SVG image request indicates to the steganography-based web browser 171 during request of the steganography-based SVG image to bypass the browser cache 172 and retrieve a new image, e.g., a steganography-based SVG image, directly from web server 180. In some embodiments, by appending the steganography-based SVG image ID token to the end of the steganography-based SVG image request, a re-cache of the steganography-based SVG image is forced upon receipt of the SVG image by steganography-based web browser 171. In some embodiments, after providing the steganography-based SVG image request to steganography-based return user identification unit 130 of web server 180, operation 335 proceeds to operation 340.

In some embodiments, at operation 340, steganography-based return user identification unit 130 of web server 180 receives the steganography-based SVG image request from steganography-configured webpage 173 via steganography-based web browser 171. In some embodiments, after receiving the steganography-based SVG image request from steganography-configured webpage 173, steganography-based SVG image determination unit 133 determines whether a steganography-based SVG image ID token is appended to the steganography-based SVG image request. In some embodiments, as stated previously, the steganography-based SVG image determination unit 133 is executable code and/or hardware configured to determine whether a steganography-based SVG image ID token is appended to the steganography-based SVG image request. In some embodiments, steganography-based SVG image determination unit 133 determines whether a steganography-based SVG image ID token is appended to the steganography-based SVG image request by scanning the steganography-based SVG image request for a steganography-based SVG image ID token.

In some embodiments, after determining that a steganography-based SVG image ID token is appended to the steganography-based SVG image request, steganography-based SVG image ID token verification unit 134 of steganography-based return user identification unit 130 verifies that the steganography-based SVG image ID token is a valid steganography-based SVG image ID token. In some embodiments, as stated previously, the steganography-based SVG image ID token verification unit 134 is executable code and/or equivalent hardware configured to verify that a steganography-based SVG image ID token included in the steganography-based SVG image request is a valid steganography-based SVG image ID token. In some embodiments, the steganography-based SVG image ID token verification unit 134 verifies that the ID token is a valid steganography-based SVG image ID token by comparing that the steganography-based SVG image ID token in the steganography-based SVG image request to steganography-based SVG image ID tokens stored at web server 180 or an associated web server database. In some embodiments, steganography-based SVG image ID tokens may be located in a steganography-based SVG image ID token list stored by the web server 180 in a database coupled to the web server 180. In some embodiments, after the steganography-based SVG image request is verified by the steganography-based SVG image ID token verification unit 134, operation 340 proceeds to operation 350.

In some embodiments, at operation 350, after verifying the steganography-based SVG image request, steganography-based SVG image generator 135 of steganography-based return user identification unit 130 generates steganography-based SVG image 150. In some embodiments, as stated previously, steganography-based SVG image generator 135 is executable code and/or hardware configured to generate the steganography-based SVG image 150. In some embodiments, steganography-based SVG image generator 135 generates the steganography-based SVG image by utilizing steganography to embed the steganography-based SVG image ID token and other information (e.g., a cache-control indicator, and an expiration date) as user identification steganography 210 into an SVG image requested by steganography-configured webpage 173. In some embodiments, steganography-based SVG image generator 135 generates the steganography-based SVG image by encrypting the steganography-based SVG image ID token and other information (e.g., a cache-control indicator, and an expiration date) as user identification steganography 210 and utilizing steganography to embed the encrypted steganography-based SVG image ID token and other information (e.g., a cache-control indicator, and an expiration date) as user identification steganography 210 into an SVG image requested by steganography-configured webpage 173. In some embodiments, the user identification steganography 210 includes, in addition to the steganography-based SVG image ID token, a cache control indicator and an expiration date. In some embodiments, for example, cache-control indicator may be, for example, a private cache control indicator, or a public cache control indicator. For example, in some embodiments, when returning the tokenized SVG asset (e.g., the steganography-based SVG image (or new SVG image)), the web server 180 sets an expires header to, for example, one year, and sets a cache-control to private. In some embodiments, the private directive indicates that the response may be meant only for an end-user and not intermediate layers (e.g., content delivery networks (CDNs)). An example of the web server 180 setting an expires header to one year and setting the cache-control to private is illustrated in the code below:
HTTP Header
Cache-Control: private;
Expires: <one_year_from_request>

In some embodiments, steganography-based SVG image generator 135 may perform steganography by modifying color values of pixels in the requested SVG image to represent the steganography-based SVG image ID token and other information, altering pixel values (e.g., least significant bits) in the SVG image to represent the steganography-based SVG image ID token, or making other imperceptible changes to the SVG image to represent the steganography-based SVG image ID token. In some embodiments, the steganography-based SVG image ID token is encrypted by steganography-based SVG image generator 135 such that the steganography-based SVG image ID token may be identified by steganography-configured webpage 173 (e.g., steganography-based SVG image detection unit 174) and decrypted by the steganography-based return user identification unit 130. In some embodiments, after generating steganography-based SVG image 150, operation 350 proceeds to operation 360.

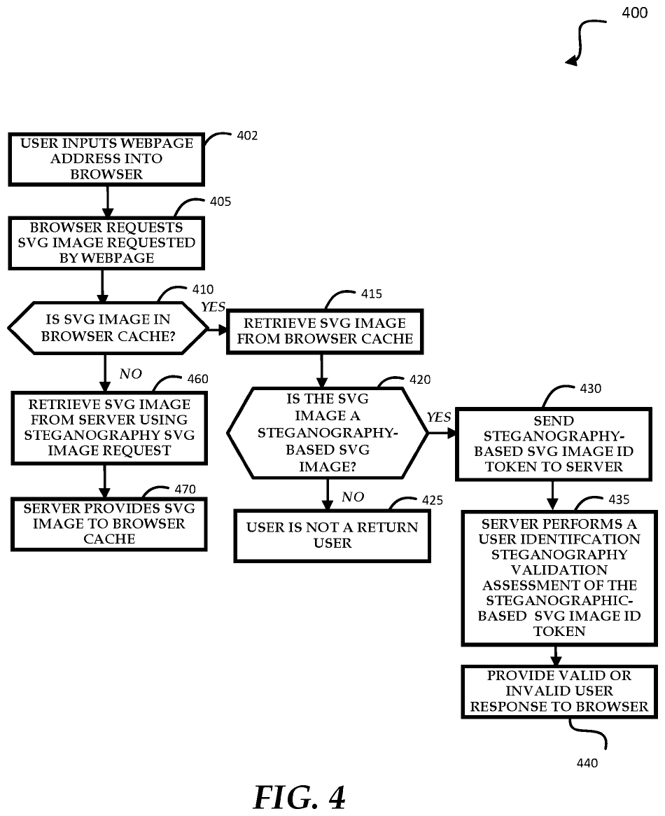

In some embodiments, at operation 360, steganography-based return user identification unit 130 of web server 180 provides the steganography-based SVG image 150 to steganography-configured webpage 173 of steganography-based web browser 171. In some embodiments, at operation 370, steganography-configured webpage 173 of steganography-based web browser 171 receives the steganography-based SVG image 150 from steganography-based return user identification unit 130 and stores the steganography-based SVG image 150 in browser cache 172. In some embodiments, steganography-based web browser 171 stores the steganography-based SVG image 150 in browser cache 172 for use by steganography-based return user identification unit 130 in determining whether user 191 of steganography-configured webpage 173 is a valid return user, as described further herein with reference to FIG. 4.

FIG. 4 illustrates a steganography-based return user identification method 400 in accordance with some embodiments. In some embodiments, the steganography-based return user identification method 400 is a method configured to utilize steganography-based SVG image 150 to identify whether user 191 is a return user of steganography-configured webpage 173. In some embodiments, the method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments. In some embodiments, the steganography-based return user identification unit 130 is configured to perform at least a portion of the steganography-based return user identification method 400 in accordance with some embodiments. In some embodiments, the steganography-based return user identification method 400 is described with reference to the figures described herein.

In some embodiments, at operation 402, user 191 inputs a URL address associated with steganography-configured webpage 173 into the address bar of steganography-based web browser 171. In some embodiments, steganography-based web browser 171 sends an HTTPS request to web server 180 for the HTML content of steganography-configured webpage 173 associated with the URL address input by user 191. In some embodiments, web server 180 responds to the HTTPS request by providing the HTML content of steganography-configured webpage 173 to steganography-based web browser 171. In some embodiments, in accessing steganography-configured webpage 173, a user authentication and a user-account-to-user device pairing assessment may be performed similar to the user authentication and user-account-to-user device pairing assessment described previously herein with reference to FIG. 3. In some embodiments, after receiving the HTML content of steganography-configured webpage 173, operation 402 proceeds to operation 405.

In some embodiments, at operation 405, after receiving the HTML content of steganography-configured webpage 173 and parsing the HTML content of steganography-configured webpage 173, steganography-based web browser 171 requests an SVG image identified as being requested by the steganography-configured webpage 173. In some embodiments, the SVG image being requested by the steganography-configured webpage 173 may be identified by steganography-based web browser 171 utilizing a tag in the HTML code that points to an SVG image. For example, in some embodiments, the HTML content of steganography-configured webpage 173 may include a tag pointing to an SVG image and the SVG image may be requested by steganography-configured webpage 173 via steganography-based web browser 171 utilizing the tag provided in the HTML content. An example of an SVG image (e.g., image.svg) that is called within HTML content of steganography-configured webpage 173 is illustrated below:
<img src=“https://mydomain.com/path-to-asset/image.svg”>.
where image.svg is the SVG image being requested by steganography-configured webpage 173.

In some embodiments, after requesting the SVG image utilizing the HTML content of steganography-configured webpage 173, operation 405 proceeds to operation 410.

In some embodiments, at operation 410, steganography-based web browser 171 determines whether the requested SVG image is in browser cache 172. In some embodiments, steganography-based web browser 171 utilizes standard SVG image fetching operations known in the art to determine whether the requested SVG image is in browser cache 172. In some embodiments, based on the determination of whether the SVG image is in the browser cache, operation 410 proceeds either to operation 415 or operation 460.

In some embodiments, at operation 460, when steganography-based web browser 171 determines that the SVG image is not located in browser cache 172, steganography-based web browser 171 retrieves an SVG image from web server 180. In some embodiments, at operation 470, web server 180 provides the SVG image to browser cache 172 for storage.

In some embodiments, at operation 415, when steganography-based web browser 171 determines that the SVG image is located in browser cache 172, steganography-based web browser 171 retrieves the SVG image from the browser cache 172 and proceeds to operation 420. In some embodiments, at operation 420, after the SVG image is retrieved from browser cache 172, a steganography-based SVG image assessment is made of the retrieved SVG image by steganography-configured webpage 173 to determine whether the SVG image is a steganography-based SVG image. In some embodiments, steganography-configured webpage 173 determines whether the SVG image is a steganography-based SVG image by utilizing a steganography-based SVG image detection unit 174. In some embodiments, steganography-based SVG image detection unit 174 is executable code that is configured to determine whether the SVG image is a steganography-based SVG image. In some embodiments, steganography-based SVG image detection unit 174 may be a script (e.g., JAVASCRIPT®) that is embedded in HTML code of steganography-configured webpage 173. In some embodiments, steganography-configured webpage 173 determines whether the SVG image is a steganography-based SVG image by finding (e.g., searching for and identifying) a steganography-based SVG image ID token (e.g., a steganography-based SVG image ID token in user identification steganography 210) in the retrieved SVG image. In some embodiments, as stated previously, user identification steganography 210 is user/user device identification data and/or information embedded in the SVG image that may be utilized to indicate that the retrieved SVG image is a steganography-based SVG image. In some embodiments, the user identification steganography 210 includes a steganography-based SVG image ID token and other information (e.g., a cache-control indicator, and an expiration date) that is encrypted and embedded in an SVG image that indicates that the SVG image is a steganography-based SVG image. In some embodiments, the user identification steganography 210 may be, for example, an encrypted steganography-based SVG image ID token embedded in the retrieved SVG image that indicates that SVG image is a steganography-based SVG image. In some embodiments, after performing the steganography-based SVG image assessment, operation 420 proceeds to either operation 425 or operation 430.

In some embodiments, at operation 425, when steganography-based SVG image detection unit 174 does not identify the SVG image as a steganography-based SVG image, user 191 is identified as not being a return user of steganography-configured webpage 173 and operations proceed as user 191 being a first-time user of steganography-configured webpage 173.

In some embodiments, at operation 430, when the SVG image is identified as being a steganography-based SVG image, steganography-configured webpage 173 provides the identified steganography-based SVG image ID token (e.g., of user identification steganography 210) to steganography-based SVG image ID token validation unit 136 of steganography-based return user identification unit 130. In some embodiments, after receiving the steganography-based SVG image ID token, at operation 435, steganography-based SVG image ID token validation unit 136 performs a user identification steganography validation assessment of the received steganography-based SVG image ID token. In some embodiments, the user identification steganography validation assessment is an assessment of the steganography-based SVG image ID token that is utilized to determine whether a returning user of steganography-configured webpage 173 is a valid user. In some embodiments, steganography-based SVG image ID token validation unit 136 utilizes the steganography-based SVG image ID token to determine whether a returning user is a valid user. For example, in some embodiments, steganography-based SVG image ID token validation unit 136 is configured to decrypt the steganography-based SVG image ID token received from steganography-configured webpage 173 to validate or invalidate the returning user. In some embodiments, by decrypting the steganography-based SVG image ID token, steganography-based SVG image ID token validation unit 136 is able to determine whether the user credentials associated with the decrypted steganography-based SVG image ID token match with user credentials stored in the database associated with web server 180 and the returning user. In some embodiments, after performing the user identification steganography validation assessment, operation 435 proceeds to operation 440. In some embodiments, at operation 440, steganography-based return user identification unit 130 provides the validation response to steganography-configured webpage 173 of steganography-based web browser 171.

The system and methods described herein improve upon the functioning of existing computers by, for example, allowing a computer (e.g., a web server) to function more efficiently by reducing the amount of hardware and software on the computer required to stop software (e.g., on a user device) from blocking cookies being used to identify return users. For example, by embedding and utilizing a preexisting SVG image with a steganography-based SVG image ID token (e.g., a steganography-based SVG image), web server 180 is able to identify the return user of the webpage using the preexisting SVG image already being accessed, which negates the need to utilize additional cookie-based hardware and technology at web server 180 to stop the blocking of the use of cookies to identify the return user, since cookies are not being utilized to identify the returning user.

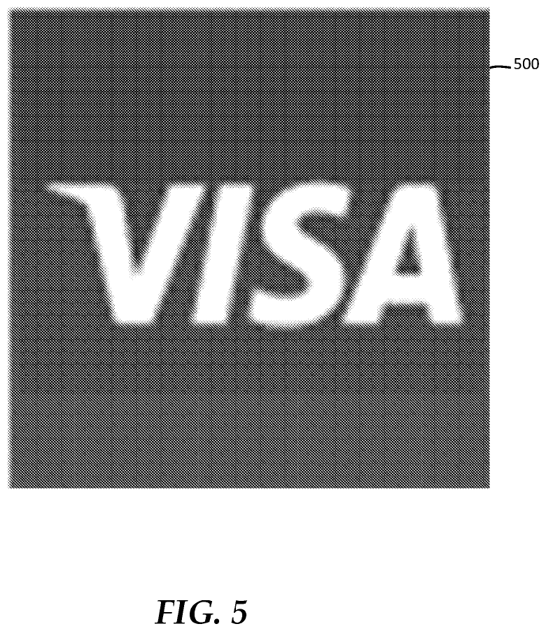

FIG. 5 illustrates an example steganography-based SVG image 500 generated utilizing the steganography-based return user identification unit 130 of FIG. 1C in accordance with some embodiments. In some embodiments, the steganography-based SVG image 500 is a Visa™M logo that includes user identification steganography that is not visually perceptible to user 191 and is used to identify whether user 191 is a return user of steganography-configured webpage 173. In some embodiments, alternate SVG images may be utilized to include the user identification steganography to identify a return user of steganography-configured webpage 173.

In some embodiments, a computer-implemented method, includes receiving, at a server, a steganography-based scalable vector graphics (SVG) image request from a browser associated with a webpage; generating, based on receipt of the steganography-based SVG image request, a steganography-based SVG image; and providing the steganography-based SVG image to a browser cache of the browser, the steganography-based SVG image being utilized to determine whether a user of the webpage is a return user.

In some embodiments, the computer-implemented method further includes utilizing a steganography-based SVG image identification (ID) token to generate the steganography-based SVG image.

In some embodiments, the computer-implemented method further includes utilizing the steganography-based SVG image ID token to determine whether the user of the webpage is the return user.

In some embodiments of the computer-implemented method, the steganography-based SVG image ID token includes information that identifies the user of the webpage.

In some embodiments of the computer-implemented method, the steganography-based SVG image ID token is configured to allow the server to identify the return user is a valid return user.

In some embodiments, the computer-implemented method further includes appending the steganography-based SVG image ID token to a URL representation of an SVG image.

In some embodiments of the computer-implemented method, appending the steganography-based SVG image ID token to the URL representation of the SVG image notifies the server that a script in the webpage is awaiting a response from the server.

In some embodiments of the computer-implemented method, steganography is utilized to embed the steganography-based SVG image ID token into the SVG image to generate the steganography-based SVG image.

In some embodiments, a system includes a processor; and a non-transitory computer readable medium coupled to the processor, the non-transitory computer readable medium comprising code that: receives a steganography-based scalable vector graphics (SVG) image request from a browser associated with a webpage; generates, based on receipt of the steganography-based SVG image request, a steganography-based SVG image; and provides the steganography-based SVG image to a browser cache of the browser for use in determining whether a user of the webpage is a return user.

In some embodiments of the system, the non-transitory computer readable medium further includes code that utilizes a steganography-based identification (ID) token to generate the steganography-based SVG image.

In some embodiments of the system, the non-transitory computer readable medium further includes code that utilizes the steganography-based SVG image ID token to determine whether the user of the webpage is the return user.

In some embodiments of the system, the steganography-based SVG image ID token includes information that identifies the user of the webpage.

In some embodiments of the system, the steganography-based SVG image ID token is configured to allow the processor to identify the return user is a valid return user.

In some embodiments of the system, the non-transitory computer readable medium further includes code that: appends the steganography-based SVG image ID token to a URL representation of an SVG image.

In some embodiments of the system, the non-transitory computer readable medium further includes code that utilizes a steganography-based SVG image ID token to generate the steganography-based SVG image.

In some embodiments of the system, appending the steganography-based SVG image ID token to the URL representation of the SVG image notifies the processor that a script in the webpage is awaiting a response from the processor.

In some embodiments, a user device includes a processor; and a non-transitory computer readable medium coupled to the processor, the non-transitory computer readable medium comprising code that receives a steganography-based identification (ID) token; receives a steganography-based scalable vector graphics (SVG) image embedded with the steganography-based SVG image ID token associated with user device identification information; and utilizes the steganography-based SVG image embedded with the steganography-based SVG image ID token to identify a user as a return user of a webpage.

In some embodiments of the user device, the non-transitory computer readable medium further includes code that: determines whether the steganography-based SVG image is embedded with the steganography-based SVG image ID token.

In some embodiments of the user device, the steganography-based SVG image ID token includes information that identifies the user of the webpage.

In some embodiments of the user device, the steganography-based SVG image ID token is configured to allow a server to identify the return user as a valid return user.

What is claimed is:

1. A computer-implemented method, comprising:
receiving, at a server, a steganography-based scalable vector graphics (SVG) image request from a browser associated with a webpage;
generating, based on receipt of the steganography-based SVG image request, a steganography-based SVG image; and
providing the steganography-based SVG image to a browser cache of the browser, the steganography-based SVG image being utilized to determine whether a user of the webpage is a return user.

2. The computer-implemented method of claim 1, further comprising:
utilizing a steganography-based SVG image identification (ID) token to generate the steganography-based SVG image.

3. The computer-implemented method of claim 2, further comprising:
utilizing the steganography-based SVG image ID token to determine whether the user of the webpage is the return user.

4. The computer-implemented method of claim 3, wherein:
the steganography-based SVG image ID token includes information that identifies the user of the webpage.

5. The computer-implemented method of claim 4, wherein:
the steganography-based SVG image ID token is configured to allow the server to identify the return user is a valid return user.

6. The computer-implemented method of claim 5, further comprising:
appending the steganography-based SVG image ID token to a URL representation of an SVG image.

7. The computer-implemented method of claim 6, wherein:
appending the steganography-based SVG image ID token to the URL representation of the SVG image notifies the server that a script in the webpage is awaiting a response from the server.

8. The computer-implemented method of claim 7, wherein:
steganography is utilized to embed the steganography-based SVG image ID token into the SVG image to generate the steganography-based SVG image.

9. A system, comprising:
a processor; and
a non-transitory computer readable medium coupled to the processor, the non-transitory computer readable medium comprising code that:
receives a steganography-based scalable vector graphics (SVG) image request from a browser associated with a webpage;
generates, based on receipt of the steganography-based SVG image request, a steganography-based SVG image; and
provides the steganography-based SVG image to a browser cache of the browser for use in determining whether a user of the webpage is a return user.

10. The system of claim 9, wherein:
the non-transitory computer readable medium further includes code that:
utilizes a steganography-based identification (ID) token to generate the steganography-based SVG image.

11. The system of claim 10, wherein:
the non-transitory computer readable medium further includes code that:
utilizes the steganography-based SVG image ID token to determine whether the user of the webpage is the return user.

12. The system of claim 11, wherein:
the steganography-based SVG image ID token includes information that identifies the user of the webpage.

13. The system of claim 12, wherein:
the steganography-based SVG image ID token is configured to allow the processor to identify the return user is a valid return user.

14. The system of claim 13, wherein:
the non-transitory computer readable medium further includes code that:
appends the steganography-based SVG image ID token to a URL representation of an SVG image.

15. The system of claim 14, wherein:
the non-transitory computer readable medium further includes code that:
utilizes a steganography-based SVG image ID token to generate the steganography-based SVG image.

16. The system of claim 15, wherein:
appending the steganography-based SVG image ID token to the URL representation of the SVG image notifies the processor that a script in the webpage is awaiting a response from the processor.

17. A user device, comprising:
a processor; and
a non-transitory computer readable medium coupled to the processor, the non-transitory computer readable medium comprising code that:
receives a steganography-based identification (ID) token;
receives a steganography-based scalable vector graphics (SVG) image embedded with the steganography-based SVG image ID token associated with user device identification information; and
utilizes the steganography-based SVG image embedded with the steganography-based SVG image ID token to identify a user as a return user of a webpage.

18. The user device of claim 17, wherein:
the non-transitory computer readable medium further includes code that:
determines whether the steganography-based SVG image is embedded with the steganography-based SVG image ID token.

19. The user device of claim 18, wherein:
the steganography-based SVG image ID token includes information that identifies the user of the webpage.

20. The user device of claim 19, wherein:
the steganography-based SVG image ID token is configured to allow a server to identify the return user as a valid return user.
